(19) United States
(12) Patent Application Publication
(10) Pub. No.: US 2022/0118470 A1
(43) Pub. Date: Apr. 21, 2022

(54) Portable fluid batching system for creating fireproofing coating material

(71) Applicant: Hy-Flex Corporation, Knightstown, IN (US)

(72) Inventors: Allen Mills, Knightstown, IN (US); Collin Goodin, Knightstown, IN (US)

(21) Appl. No.: 16/974,366

(22) Filed: Dec. 3, 2020

Related U.S. Application Data
(60) Provisional application No. 62/943,023, filed on Dec. 3, 2019.

(51) Int. Cl. B05B 12/08; B05B 15/25; B05B 13/00; B05B 12/00

(52) U.S. Cl. CPC B05B 12/087; B05B 12/002; B05B 13/005; B05B 15/25

(57) ABSTRACT

A portable water batching system for mixing fireproofing coatings. A controller allows the user to pre-set the volume of a batch of water to be dispensed into the mixer for the fireproofing coating. The water batching system can also be used in conjunction with an acid/activator injection system that allows an acid solution to be introduced to the fireproofing coating slurry prior to reaching the spray gun used for application. The water batching system and acid injection system can be used in tandem with a system that proportionally controls the amount of acid solution pumped from the acid injection system to the amount of fluid pumped from the water batching system. The systems can each be equipped with data sensors to allow for recording of information for each batch of fireproofing coating.

### CROSS REFERENCE TO RELATED APPLICATIONS

This application claims benefit of Provisional Application Ser. No. 62/943,023 filed Dec. 3, 2019, the disclosure of which is incorporated herein in its entirety.

### FIELD OF THE INVENTION

The present invention relates to systems for making spray-applied fire-resistive materials (“SFRM”).

### BACKGROUND

Spray-applied fire-resistive material (“SFRM” or “fireproofing coating material”) is construction material typically created at a construction site. Other examples of such construction materials include mortars, plasters, epoxy, and other thick-bodied construction coatings containing small aggregates less than ⅜ inch.

To prepare fireproofing coating material, solid fireproofing coating powder is put into a mixer. Water or other suitable fluid is then introduced into the mixer and mixed with the powder to create a fireproofing coating slurry. The slurry is then pumped through a hose to a spray gun, which is used by an operator to apply the slurry to building surfaces, including decking, columns, metal supports, girders and the like. Often, an accelerator such as a solution containing alum may be introduced to the flow of slurry just prior to the spray gun. The accelerator enhances the property of the fireproofing coating slurry, e.g., by allowing it to cure or set more quickly. After application to the building surfaces, the slurry cures, which bonds it to the structure, thus forming a final fireproofing coating.

Prior to the application of fireproofing coating slurry, an inspection should be made to ensure that all surfaces are acceptable to receive fireproofing. Steel should be free of oil, grease, rolling compounds or lubricants, loose mill scale, excess rust, noncompatible primer, lock down agent, or other substances that will impair proper adhesion. Where necessary, steel surfaces should be cleaned to receive fireproofing coating. Some fire resistant designs allow the use of painted metal floor or roof-deck in place of galvanized decking. Painted decking should be UL listed in the specific fire resistance designs. Before applying fireproofing coating material, a bonding agent may be applied to concrete substrates. Often, application to the underside of roof deck assemblies is done only after roofing application is complete and roof traffic has ceased. Further, no application occurs prior to completion of concrete work on steel decking. Other trades often do not install ducts, piping, equipment, or other suspended items until the fireproofing is completed and inspected. However, other trades typically install clips, hangers, support sleeves, and other attachments that penetrate the fireproofing, prior to application of the fireproofing material.

Finished fireproofing coating should have properties specified by the powder manufacturer, such as density, bond strength, bond impact, thickness, compression, resistance to corrosion, deflection, resistance to mold growth, surface bonding, and lack of combustibility. Some of these properties may also be dictated by local building codes. The desired properties may vary depending on the type of building surface to which the coating is applied. For example, a fireproofing coating on exposed girders may need to have properties different than a fireproofing coating on a concrete column.

Objectives for fireproofing coating materials, its application, and cured form include in-place performance, low in-place cost, fast, efficient application, and building code compliance.

To achieve desired properties for a specific coating application, precise measurement and mixing of the fireproofing powder and liquid is essential, especially as improved formulations for fireproofing coating powder are developed.

Fireproofing coating powder and liquid are typically mixed at the construction site in a mixer, then dumped into a vat where it is pumped to spray guns. While the mixed material in a vat is being pumped, a new batch of fireproofing material may be mixed in the mixer, then dumped into the vat. It may take 2-8 minutes to mix each batch of fireproofing coating material. In an ideal operation, the amount of time required to apply each batch of fireproofing material is about the same amount of time required to mix a new batch, so an uninterrupted process of mixing and applying the construction material is maintained.

Conditions at construction sites where fireproofing material and other construction materials are mixed vary. The ambient temperature during mixing and application can affect the final properties. However, construction sites are often unheated, or heated at irregular time intervals to minimize heating costs. In addition, temporary and limited electrical service is often provided, with multiple contractors at a site tapping into the electrical power at various times. During times of heavy electrical load, source power voltage may vary by about 10%. The performance of electrical equipment, such as motors or pumps used to meter liquid for fireproofing coating material for predetermined time periods, may be affected by such variations.

Similarly, the pressure of a water supply may vary considerably depending on various factors including utility-supplied water pressure, the distance of the mixer from the liquid or water supply, and the number of floors up which the liquid or water must be pumped. These and other factors can result in variability in the amount of liquid in a batch of construction material, especially when the duration a valve is open is the primary metric used to measure the amount of liquid to be used. Thus, systems for accurately metering ingredients for fireproofing coating material are increasingly important, especially given the ever-more precise specifications required for the final applied fireproofing coating. In addition, it is desirable that systems for manufacturing or mixing the fireproofing coating material be portable, as a building may have a large surface area or multiple floors to be treated.

Variations in water pressure have resulted in contractors using a separate holding tank for liquid, and then transferring the liquid at a high flow volume to the mixer. Previously, manually actuated valves have been used to estimate the volume of liquid dispensed and to shut off the flow of liquid. However, this requires trained personnel to monitor the liquid flow and to turn off the valve at an appropriate time.

It is also known to use a timer that turns off a pump that is providing liquid to a mixer after a specified time. The reason for using this method is that batch mixing times require 2-4 minutes of mixing time and the water may need to be dispensed in 30-60 seconds to keep up with the application process of the coating being mixed and applied. However, the use of timers does not meet today's high standard for labor, material, and quality management, especially considering that the pumping volume may vary due to: (a) fluctuations in supply voltage; and (b) the amount of water pressure downstream of the pump due to factors such as the length of the hose after the pump, or the height to which the water must be pumped. Mismeasurement of the liquid can result in the fireproofing coating varying from specification, which affects the application rate, bond strength, application, appearance and other qualities of the final coating.

Existing systems also do not facilitate convenient automatic and easy recording of data regarding the mixing of construction coatings. This does not allow compliance with mixing and application specifications to be suitably certified. The system and methods disclosed herein are especially helpful for construction materials involving the quick dispensing of a large amount of water or other liquid in a short amount of time into a mixer.

### SUMMARY OF THE INVENTION

One object of the present invention is to provide a portable water batching system to be used in mixing fireproofing coatings. A controller allows the user to pre-set the volume of water to be dispensed into the mixer to be mixed with the powder for the fireproofing coating. The volume of water that flows through the system is measured using a flowmeter and the flow is controlled using a solenoid valve. This desirable because measuring water only by time leads to varying volumes of water due to variations in water pressure.

A high-output pump of at least 10 gallons per minute is desirable to keep up with the high demand on a job site. An optional component to be used with the batching system is a pressure washer that can be used to clean the system or other construction tools/vehicles.

The water batching system can also be used in conjunction with an acid/activator injection system that allows an acid solution to be introduced to the fireproofing coating slurry prior to reaching the spray gun used for application. The addition of the acid/activator can increase the yield of the fireproofing coating and allow for a quicker setting time.

The water batching system and acid injection system can be used in tandem with a system that proportionally controls the amount of acid solution to the amount of fluid from the water batching system. The systems can each be equipped with data sensors to allow for recording of various statistics for each batch of fireproofing coating. This is desirable to track productivity and materials used at job sites.

### BRIEF DESCRIPTION OF THE DRAWINGS

FIG. 1 shows a perspective view of a mixer and pump known in the art.

FIG. 2 shows a side view of the portable water batching system on a cart with a close up view of the water inlet.

FIG. 3 shows a perspective view of the portable water batching system on a cart with an inside view of the water tank showing the float valve.

FIG. 4 shows a perspective view of the portable water batching system on a cart with an inside view of the water tank showing the sump pump and internal plumbing.

FIG. 5 shows a front view of the control box.

FIG. 6 shows a top view of a remote control.

FIG. 7 shows a perspective view of an acid injection system comprising a tank, an agitator, and a pump on a portable cart.

FIG. 8 shows a perspective view of the portable water batching system, acid injection system, and a pressure washer on a cart.

FIG. 9 shows a manifold having inlets for the fireproofing coating slurry and the acid solution with an outlet leading to a spray gun used to apply the fireproofing coating spray.

### DETAILED DESCRIPTION

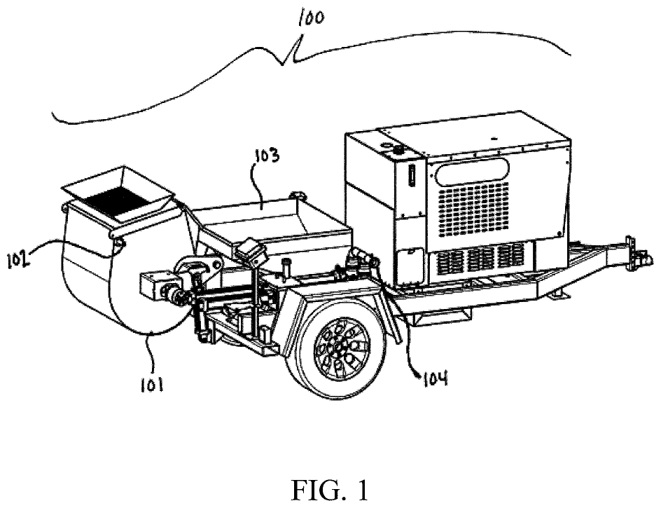

The system is designed to be used with a fireproofing material or other construction material manufacturing system that includes a mixer 100 having a mixing tub 101 as shown in FIG. 1. Bags of fireproofing powder are emptied into the mixing tub 101. The mixing tub 101 includes a fluid inlet 102 attachable to a hose. An optional mixer water bar may be attached to the inside of the mixer 101 and the fluid inlet 102 to evenly distribute the fluid to the powder in the mixing tub 101. The mixer water bar can also act as a self-cleaning system for the mixing tub 101.

The fireproofing powder and fluid are typically mixed for 2-6 minutes in the mixing tub 101 to create a slurry, which is then dumped into a pump hopper 103. A reciprocating pump or rotary pump pumps the slurry through the pump outlet 104 and into a hose, which transports the slurry to the location where it is to be applied.

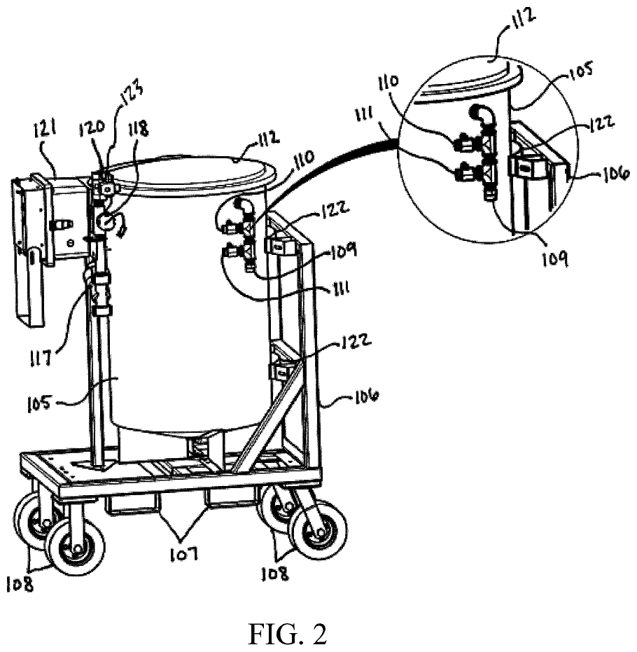

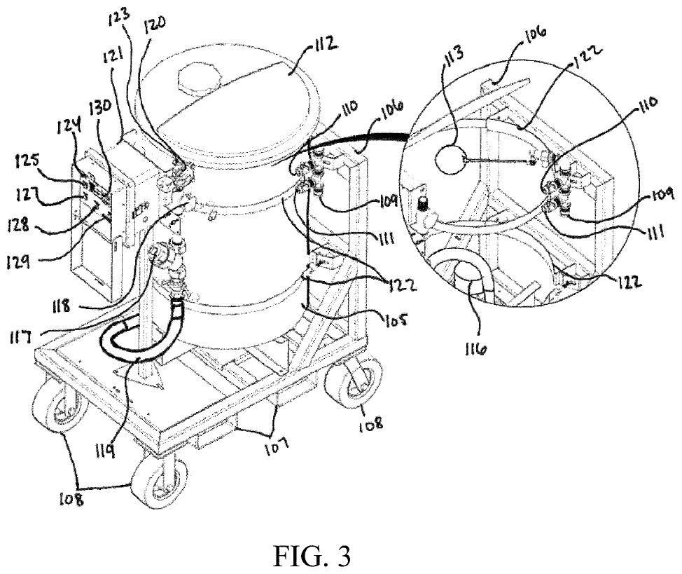

The liquid is provided to the mixing tub 101 through the fluid inlet 102 via the water batching system in accordance with the present disclosure as shown for example, in FIG. 2. The water batching system includes a tank 105 with a lid 112 for storing fluid such as water. The tank 105 may be mounted and/or attached to the frame of a wheeled cart 106 using straps 122 to provide easy portability, as shown in FIG. 3. The wheels 108 for the cart can be casters to allow the cart to move in any direction for easy maneuverability. The frame of the cart 106 may also be equipped with forklift pockets 107 to allow a user to easily lift and transport the system.

As shown in FIG. 2, the water is introduced to the tank 105 near its top by a fluid inlet 109, which may be connected to a conventional water source by a hose. The fluid inlet 109 is further connected to two water outlets 110, 111 which can be used with auxiliary hoses for cleaning purposes or to keep the water moving in the tank 105 during cold weather to avoid freezing. The fluid inlet 109 is also attached to a float valve 113 so that when the fluid in the tank 105 approaches the top, the float 113 rises and closes the inlet valve 109 to prevent the tank 105 from overflowing, as shown in FIG. 3.

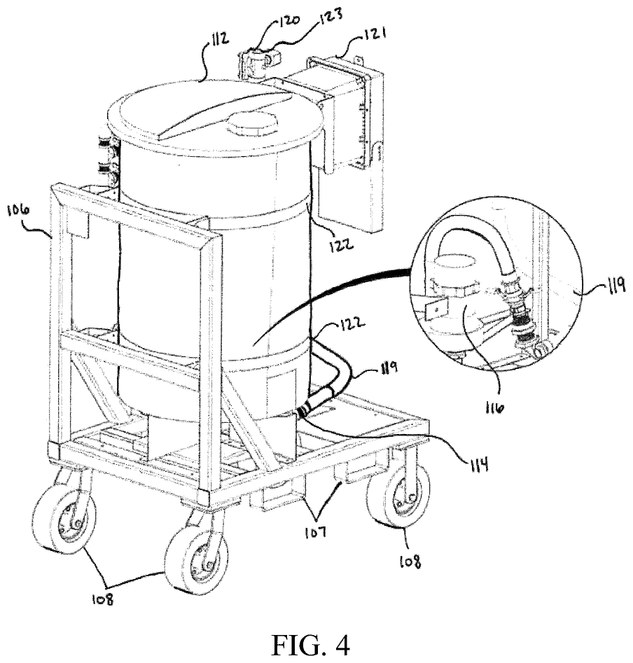

A sump pump 116 in the bottom of the tank 105, as shown in FIG. 4, forces water within the tank 105 through a hose 119 which connects to a filter 117, as shown in FIG. 3. The water then travels through a rotary flowmeter 118. See FIG. 3. The flowmeter 118 may be similar to those from Gems Sensors (www.gemssensors.com). The flowmeter 118 generates signals indicating the volume of water that passes through it. These signals are provided to a controller, that can be similar to a Veeder-Root C346 Controller (www.veeder.com) or an Icon controller from Parker (https://www.parker.com/portal/site/PARKER/menuitem.223a4a3cce02e b6315731910237ad1ca/?vgnextoid=d3bc7433cb65e210VgnVCM10000 048021dacRCRD&vgnextfmt=EN).

As shown in FIG. 3, after passing through the flowmeter 118, the liquid passes through a solenoid valve 120. The solenoid valve 120 allows the system to control the amount of liquid that is pumped from the tank 105 through the tank outlet 114 (FIG. 4) and into the mixing tub 101 by opening and closing in response to signals from the controller. The fluid outlet 123 of the system is connected by a hose to the fluid inlet 102 of the fireproofing mixer tub 101 as discussed above.

The controller is housed in a control box 121 that is mounted to a frame for the system. The control box 121 can further house a display such as an Nan display from Parker (https://www.parker.com/portal/site/PARKER/menuitem.223a4a3cce02e b6315731910237ad1ca/?vgnextoid=d3bc7433cb65e210VgnVCM10000 048021dacRCRD&vgnextfmt=EN). A controller may also be implemented by a PC (personal computer) or PLC (programmable logic controller). The controller may be programmed to allow any desired metric for liquid to be specified for a batch, such as gallons, liters, ounces, etc. using a button or touch screen system (user interface) 130.

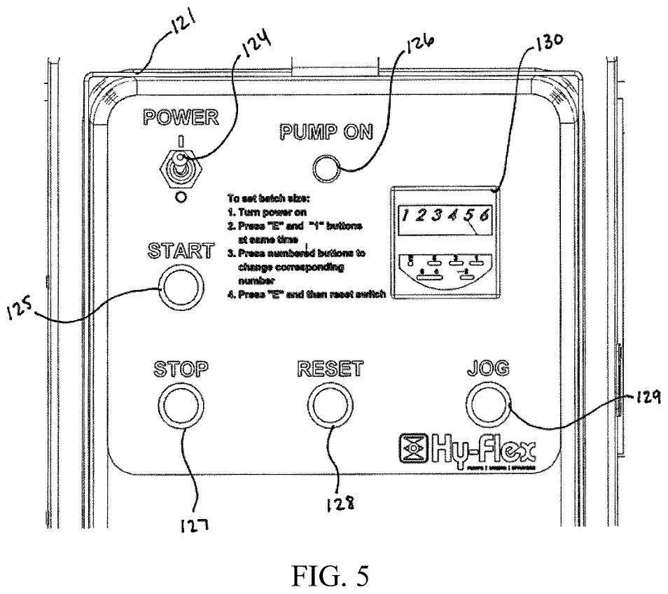

As shown in FIG. 5, the control box 121 includes a power on-off switch 124 and a “pump on” indicator light 126 to show when the power is to the batching system is turned on. A controller is contained within the box 121 and is programmed using conventional techniques to allow an operator to specify a volume of liquid to include in a batch via a digital touch screen, buttons, or other user interface 130. The user interface 130 as shown contains several buttons used as a means for specifying a volume of liquid to be output via the liquid output 123 for a batch. For example, using the interface 130, a user can program the volume and unit of measurement for the fluid to be pumped through the system. Once a volume of liquid to be pumped by the system is specified, a green “start” button 125 is pushed. The start button 125 is a means operable to begin the pump 116 outputting liquid from the tank 105 through the liquid output 123. This causes the controller to supply power to the sump pump 116 in the tank 105 and send a signal to open the solenoid shut-off valve 120. As fluid passes through the flowmeter 118, the controller monitors the volume of water passing through it. When the specified volume of water has passed through the flowmeter 118, the controller sends a signal to close the solenoid valve 120 and turns the sump pump 116 off. The flowmeter 118 and controller act as a means to automatically stop the pump 116 when a specified volume of liquid for the batch has passed through the liquid output 123.

To change the amount of programmed volume to be pumped, the user can press the reset button 128 and re-program the amount using the interface 130. If the user wants to stop the flow of liquid for any reason, for example, if a hose has a leak, they can press the red “stop” button 127. The stop button 127 is also useful for situations when an operator determines that a batch of material to be mixed has a sufficient volume of liquid in it already, even if a greater volume was been pre-programmed into the controller. Pushing the stop button 127 sends a signal to turn off the sump pump 116 and close the solenoid valve 120.

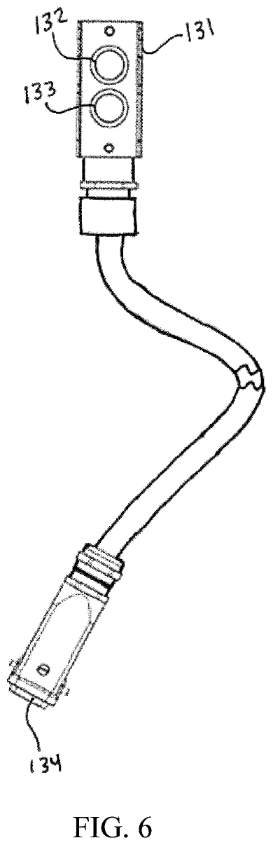

The control box 121, as shown in FIG. 5, may also include a manual jog (or override) switch 129, which operates to turn the sump pump 116 on and opens the solenoid valve 120. This is useful for fine-tuning the amount of liquid dispensed to the mixing tub 101. For example, for the first batch of fireproofing coating mixed in the day, additional fluid may need to pass through the flowmeter 118 to account for the volume of water within the hose between the solenoid valve 120 and the mixing tub fluid inlet 102. Alternatively, the operator of the spray gun may desire a slurry having a thinner viscosity if the surface to be coated requires a lower thickness, or if the ambient temperature warrants a coating of lower viscosity or density. The amount of fluid added via the manual jog switch 129 may be measured by the controller. If the manual jog switch 129 is used, the flow may be stopped by pressing the red stop batch button 127 on the control box 121 or the stop batch button 133 on the remote control 131 as shown in FIG. 6.

The remote control 131 can be equipped with a start batch button 132 and a stop batch button 133 which each send signals as discussed above for the start and stop buttons 125, 127 on the control box 121. The remote control 131 is connected to the control box 121 by an electric cable 134. This is helpful for situations when the control box 121 is distant from the mixer 100, so that an operator away from the mixer 100 or the water batching system may start the flow of liquid into the mixer 100. The remote control 131 may be attached to a magnet, so it may be affixed to the metal frame of the mixer 100 or the cart 106 for the water batching system if desired.

Of course, the remote control 131 described above may also be provided with stop batch, jog, and/or override buttons to permit activation of these features from a location remote from the control box 121. Additionally, the remote control 131 may have input buttons that allow the user to enter a specific amount of water to be dispensed.

The system also includes appropriate power cords for supplying power to the control box 121 and sump pump 116.

A display on the control box 121, and/or remote control 131 may also show data collected or stored in the system, including but not limited to dates, times, batch numbers, batch start and stop times, construction material characteristics such as temperature and density, operator name, job description, and the like. In another embodiment, the functions of the remote buttons and displays may be implemented via an app running on a smartphone.

An app may be used to access a central database to display information regarding the batches being applied from a variety of job sites in which the system described herein is implemented. This allows a construction supervisor to ensure that construction projects are staying on schedule throughout a day, and to quickly identify problems requiring an intervention. Information from the central database can also compare the efficiency and effectiveness of multiple work crews to which construction projects have been assigned.

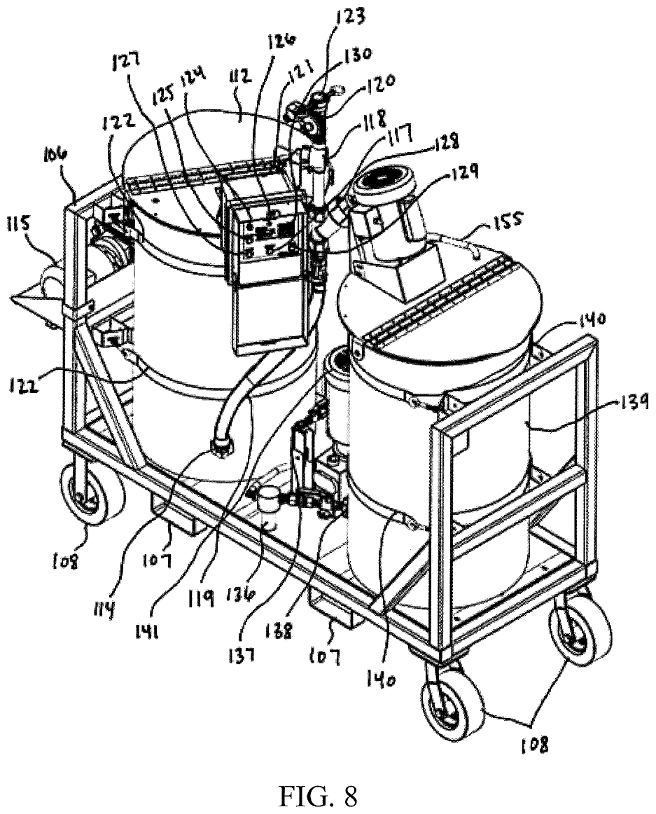

Optionally, the frame 106 may hold a pressure washer 115 as shown in FIG. 8. At the conclusion of a job, the lower outlet valve 114 may be connected to the pressure washer 115 to supply high-pressure water, which may be used to clean the mixer 100 and other components used for applying fireproofing coating or for construction equipment generally.

The portable frame 106 may optionally hold an injection system as shown in FIG. 8. An injection system injects an activator such as an alum acid solution into the fireproofing coating slurry. The activator reduces the setting time of the applied slurry, which in turn allows a second coat to be applied sooner. An activator can also help the applied slurry swell, which increases the yield from the fireproofing coating powder.

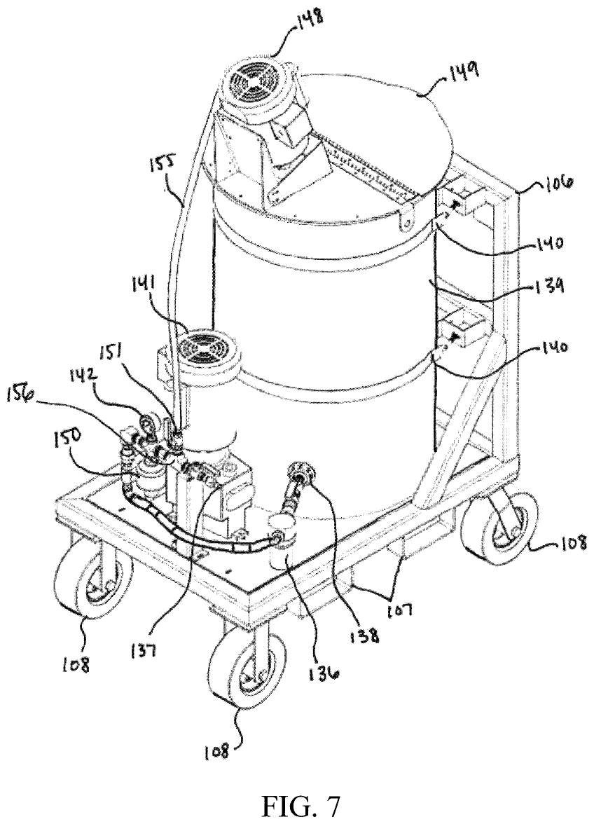

As shown in FIG. 7, an injection system (mounted on a separate frame) may include a tank 139 suitable for holding a solution. The tank can be attached or strapped to the cart using straps 140. An acid, such as alum, is mixed with water in the tank 139, and a mechanical agitator 148 may be attached to the lid 149 of the tank and applied to the combination to ensure thorough mixing into a solution or suspension.

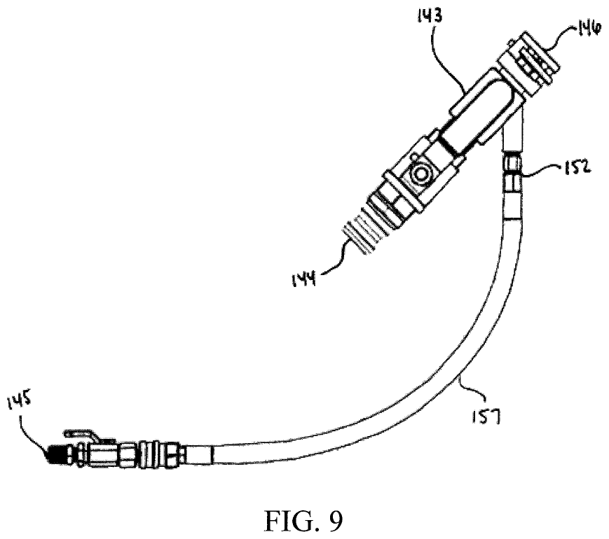

The combination is then pumped from the tank 139 by an injection pump 141. The injection pump 141 may be a positive displacement diaphragm or a chemical metering pump adapted to dispense at a specified rate. The pumping rate may be determined by a mechanical dial on the injection pump, or through an electronic means. The pump 141 will pump the alum/activator mixture from the tank outlet 138 through a filter 136. The solution then travels through a pressure gauge 142 fitted with a pulsation dampener 150 to a t-valve 156. The t-valve 156 has two outlets. The first, is an outlet 151 connected to a hose 155 that recirculates the solution within the tank 139. The second, is an outlet 137 that disperses the acid solution into a hose to a manifold inlet for the acid solution 145 as shown in FIG. 9. As further shown in FIG. 9, the hose 157 leading from the manifold inlet for the acid solution 145 to the manifold 143 is fitted with a check valve 152, to avoid backflow. The manifold 143 is typically positioned 25-50 feet upstream from the spray gun.

Alternatively, the injection pump 141 may be a variable speed motor whose output may be correlated with the output set for the slurry pump in accordance with desired parameters. In one embodiment, a control system is provided that monitors the fireproofing coating slurry, and is calibrated to automatically adjust the output of the alum or activator injection pump, so that a desired ratio is maintained. The pump 141 may be hydraulic, rotary, or reciprocating. This allows the amount of volume being pumped through the injection system to be converted to a volumetric flow per minute. Once that amount is calculated, the user can change with variable speed the motor on the injection pump 141 allowing it to slow down or speed up proportionally to the rate of flow from the water batching system.

FIG. 9 shows a manifold used to combine the alum/activator mixture with the fireproofing coating slurry prior to application. As shown in FIG. 9, the manifold 143 has inlets for the fireproofing coating slurry 144 and the alum/activator mixture 145, and an outlet 146 to connect to a whip hose. The whip hose may be about 25-50 feet in length, and its opposite end may be connected to a spray gun (not shown) for applying the fireproofing coating slurry. This arrangement allows the acid to mix with the slurry in the hose, thus activating it via a chemical reaction to improve its setting characteristics when sprayed onto building surfaces.

In one embodiment, the system may include sensors and data collection systems that automatically detect and report data regarding the use of the system. Data that may be collected and stored includes:
Amount of water in tanks
Amount of slurry in mixer
Amount of slurry in pump hopper
Date and start time of day for each batch
Amount of programmed liquid for batch
Amount of manually added liquid for batch
Duration of dispensing of liquid for batch
Amount of actual liquid dispensed for batch
Date and end time of day for each batch of liquid dispensed
Liquid temperature at batch at tank
Ambient temperature at batch tank
Liquid temperature at mixer
Ambient temperature at batch tank
GPS of batch tank
GPS of mixer
Flow rate of fireproofing coating slurry at periodic intervals
Flow rate of activator at periodic intervals
Dates and times of day when fireproofing coating slurry is being applied
Density of fireproofing coating slurry at periodic intervals
Viscosity of fireproofing coating slurry at periodic intervals
Weight of fireproofing powder in mixing vat
Density of fireproofing coating slurry at mixing vat
Mixing time of coating slurry at mixing vat
Flow rate of activator
Total amount of fireproofing material powder in batch
Total amount of fireproofing material powder used per day
Total amount of water in batch
Total amount of water used per day
Total amount of slurry pumped from hopper
Identity of operators

In one embodiment, this data is automatically and continuously detected by sensors at the various components, then provided via a communications protocol such as Bluetooth to the central database. Reports may be generated from the central database to provide quality control and worker efficiency information.

Monitoring and recording this data is especially important because the environment and requirements for applying fireproofing coating can change throughout a day. For example, the coating density, thickness, and flow rates required may vary considerably depending on the type of surface to which the coating is applied, e.g., whether decking, columns, or girders.

The term “fireproofing coating liquid” as used in the claims means any desired liquid that may be mixed with a fireproofing coating powder to create a fireproofing coating slurry, and may include water. While the embodiment disclosed herein utilizes an electrically powered pump, a pump powered by other means such as a liquid fuel or hydraulic power source may also be used.

Those of skill in the art will understand that various details of the invention may be changed without departing from the spirit and scope of the invention. Furthermore, the foregoing description is for illustration only, and not for the purpose of limitation, the invention being defined by the claims. For example, while fireproof coating has been described as the exemplary construction material with which the system may be used, the systems and methods described herein may be used with other coatings such as mortars, plasters, epoxy, and other thick-bodied construction coatings containing small aggregates.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1. A fireproofing coating liquid dispensing system comprising
a portable frame;
an electrical input;
a liquid tank on the portable frame for holding liquid comprising:
a fireproofing coating liquid input source
a fireproofing coating liquid output
a pump intermediate the input source and the liquid output;
a volumetric meter intermediate the input source and the liquid output;
a control system in communication with the volumetric meter comprising:
means for specifying a volume of liquid to output via the liquid output for a batch;
means operable to begin the pump outputting liquid from the tank through the liquid output;
means to automatically stop the pump when a specified volume of liquid for the batch has passed through the liquid output.

2. The system of claim 1 in which the pump has an output flow capacity of at least 10 gallons per minute.

3. The system of claim 1 in which the liquid tank further comprises a liquid drain.

4. The system of claim 1 in which the pump is a sump pump located within the tank.

5. The system of claim 1 further comprising sensors operable to automatically and continuously transmit data to a central database from which reports may be generated to provide quality control or worker efficiency information.

6. The system of claim 1 in which the system is controlled and data is provided by an app running on a wireless device.

7. The system of claim 1 further comprising:
a handle for moving the portable frame.

8. The system of claim 1 further comprising:
a means to manually pump liquid through the system.

9. The system of claim 1 further comprising:
a means to manually stop the volume of liquid to output via the liquid output for a batch.

10. The system of claim 1 further comprising:
a pressure washer to be used with the volume of liquid output via the liquid output.

11. The system of claim 1 further comprising:
a remote control with the means to:
manually pump liquid through the system.
manually stop the volume of liquid to output via the liquid output for a batch.

12. The system of claim 11 further comprising:
a magnet to hold the remote control to the portable frame.

13. The system of claim 1 further comprising:
fork lift pockets on the portable frame.

14. The system of claim 1 further comprising:
a mixer to receive:
fireproofing coating liquid from the fireproofing coating liquid output;
a fireproofing coating powder.

15. The system of claim 1 in which the frame holds an activation system comprising:
a mixing tank for holding activation fluid;
an agitator operable to agitate the activation fluid;
a pump for pumping the activation fluid to a flow of fireproofing material slurry;
a sensor calculating a volume of the activation fluid pumped.

16. The system of claim 15 further comprising:
a controller proportionally controlling the volume of liquid dispensed from the fireproofing coating liquid dispensing system and the volume of the activation fluid pumped.
